(19) United States
(12) Patent Application Publication
(10) Pub. No.: US 2026/0322869 A1
(43) Pub. Date: Oct. 15, 2026

(54) MANAGING SOFTWARE SERVICE OPERATIONS IN MULTI-NODE ENVIRONMENTS

(71) Applicant: Red Hat, Inc., Raleigh, NC (US)

(72) Inventors: Michael Engel, Grasbrunn (DE); Eric Curtin, Dublin (IE)

(73) Assignee: Red Hat, Inc., Raleigh, NC (US)

(21) Appl. No.: 19/179,311

(22) Filed: Apr. 15, 2025

(51) Int. Cl. H04L 67/10

(52) U.S. Cl. CPC H04L 67/10

(57) ABSTRACT

A system can be provided for managing software service operations in multi-node environments (e.g., edge computing systems). For example, the system may receive a request to execute an external event from an input device of an edge computing system. In response to receiving the request to execute the external event, the system may identify one or more operations involved in execution of the external event based on configuration data associated with the edge computing system. The system may then control one or more computing nodes to execute the external event by causing the computing nodes to perform the operations.

### TECHNICAL FIELD

The present disclosure relates generally to edge computing environments. More specifically, but not by way of limitation, this disclosure relates to managing software service operations in multi-node environments.

### BACKGROUND

Distributed computing systems (e.g., cloud computing systems, data grids, and computing clusters) have recently grown in popularity given their ability to improve flexibility, responsiveness, and speed over conventional computing systems. In some cases, the responsiveness and speed of distributed computing systems can be further improved by employing edge-computing solutions. Edge computing is a networking philosophy focused on bringing computing power and data storage as close to the source of the data as possible to reduce latency and bandwidth usage. Distributed computing environments may employ edge devices to perform various functions at the edge.

### BRIEF DESCRIPTION OF THE DRAWINGS

FIG. 1 is a block diagram of an example of a multi-node computing environment in which software service operations can be managed, according to some aspects of the present disclosure.

FIG. 2 is a block diagram of a computing environment for managing software service operations in multi-node environments, according to some aspects of the present disclosure.

FIG. 3 is a flow chart of an example of a method managing software service operations in multi-node environments, according to some aspects of the present disclosure.

### DETAILED DESCRIPTION

In multi-node computing environments (e.g., distributed edge computing systems), controlling and automating software service interactions across multiple computing nodes can be difficult. Current solutions for controlling and automating software service interactions (e.g., Kubernetes) are defined for private or public cloud environments where computing resource availability is relatively high. In contrast, computing resources (e.g., CPU, memory, and storage) of edge nodes in edge computing systems are often limited. Therefore, computing resource requirements of the existing solutions for controlling and automating software service interactions (e.g., Kubernetes) may be too high for the existing solutions to be applicable to edge computing systems. Instead, custom software applications may be created for managing and tracking states of edge nodes and for orchestrating software services across different edge nodes. However, the creation of such custom software applications may be time consuming and error prone. For example, it may be time consuming to develop a software application that can dynamically adapt a workflow based on real-time events occurring within an edge computing system. Additionally, due to a wide variety in hardware of edge nodes, edge nodes operating in low-bandwidth, intermittent, or high-latency networks, or other attributes of edge nodes, a custom software application may often exhibit errors while trying to track and orchestrate software service interactions among edge nodes.

Some examples of the present disclosure can overcome one or more of the abovementioned problems by using a state manager to manage software service operations in multi-node environments. The state manager may access configuration data that defines operations, events, and workflows for each computing node in a multi-node environment (e.g., each edge node in an edge computing system). Additionally, a stateless (e.g., multi-node) service manager (e.g., BlueChi) may provide, to the state manager, information related to states of the computing nodes in the multi-node environment, states of software services running on the computing nodes, or a combination thereof. Accordingly, the state manager can use the configuration data, the information related to the states of the computing nodes in the multi-node environment, the information related to the states of the software services running on the computing nodes, or a combination thereof to coordinate software service operations across the computing nodes. As such, the state manager may provide a standardized and configurable solution for multi-node state management and software service orchestration. Consequently, the state manager can reduce a need for complex, custom software applications to be built for multi-node environments (e.g., edge computing systems).

Additionally, the state manager may maintain state information (e.g., the information related to the states of the computing nodes, the states of the software services running on the computing nodes, or the combination thereof) in volatile memory. Storing the state information in volatile memory may reduce a need for persistent storage, thereby reducing computing resource requirements of software service management by the state manager in comparison with the existing solutions. Thus, the state manager may be a lightweight solution for managing software service interactions. Moreover, by maintaining the state information in volatile memory, error recovery and state resets may be simplified. For example, because the state information is stored in volatile memory, upon a crash or reboot of the multi-node environment (or of a node in the multi-node environment), the multi-node environment (or the node) may restart without an attempt to recover complex or corrupted data. Instead, up-to-date state information can be obtained from an upstream source or input (e.g., the service manager), which is more accurate, secure, and computing resource efficient than data recovery.

In a particular example, the state manager may be executing on an edge computing system. The edge computing system may be a vehicle. The state manager may receive a request to execute an external event (e.g., a request to open a trunk of the vehicle) from an input device (e.g., a key fob) of the edge computing system. The state manager may receive the request to execute the external event as a result of a user hitting a button for opening the trunk on the key fob.

In response to receiving the request to execute the external event, the state manager may identify at least one operation involved in execution of the external event based on configuration data associated with the edge computing system. For example, the configuration data may include logic defined in a YAML file. The logic defined in the YAML file may outline three operations to be performed when executing the external event (e.g., when opening the trunk). The operations may include a park-mode operation, a start-collision-senor operation, and an open-backdoor operation. The YAML file may indicate that the park-mode operation involves checking if the vehicle is in a park mode, the start-collision-sensor operation involves starting a collision sensor, and that the open-backdoor operation involves opening the trunk of the vehicle. The logic defined in the YAML file may further outline an order in which the operations are to be performed (e.g., the park-mode operation, then the start-collision-sensor operation, and then the open-backdoor operation). Additionally, the logic defined in the YAML file may indicate that performance of each operation depends on success of a preceding operation (e.g., that the start-collision-sensor operation depends on the car being in park mode and that the open-backdoor operation depends on the collision sensor being active).

After the state manager identifies the operations from the configuration data, the state manager may control at least one computing node of the edge computing system to execute the external event by performing the operations. In the particular example, the state manager can control a first computing node of the edge computing system by transmitting a request for the first computing node to perform the park-mode operation to a service manager. The service manager may then cause the first computing node to perform the park-mode operation. For example, a command transmitted by the service manager to the first computing node may activate a park-mode software service on the first computing mode.

The state manager may then detect that the park-mode operation was performed successfully (e.g., that the vehicle is in park mode). Consequently, the state manager may transmit a request for a second computing node to perform the start-collision-sensor operation to the service manager. In response, the service manager may cause the second computing node to perform the start-collision-sensor operation. That is, the service manager may cause a collision sensor of the vehicle to activate.

Additionally, the state manager may detect that the start-collision-sensor operation was performed successfully (e.g., that the collision sensor is active). The state manager may then transmit a request for a third computing node to perform the open-backdoor operation to the service manager. In response, the service manager may cause the third computing node to perform the open-backdoor operation. Namely, the service manager may activate a liftgate of the vehicle to cause the lift gate to open the trunk of the vehicle.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

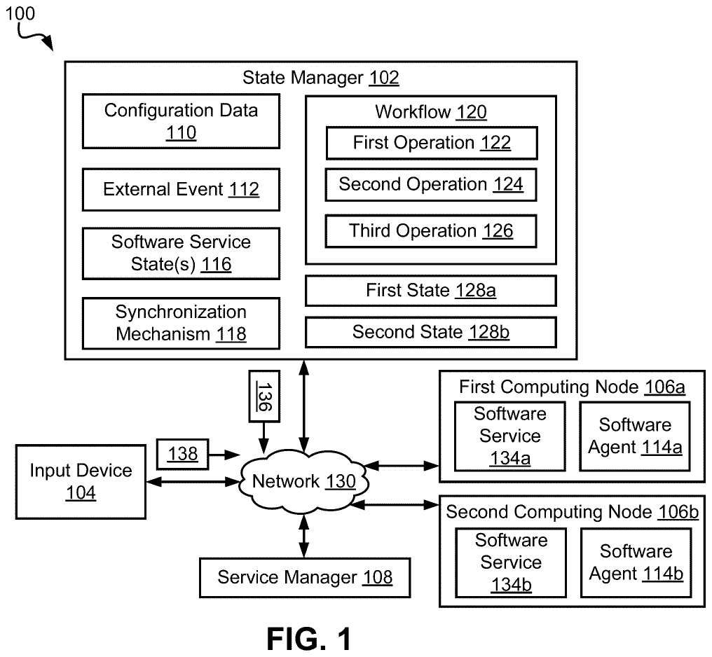

FIG. 1 is a block diagram of an example of a multi-node computing environment 100 in which software operations can be managed, according to some aspects of the present disclosure. The multi-node computing environment 100 includes a state manager 102, a service manager 108, an input device 104, a first computing node 106a, and a second computing node 106b. Components within the multi-node computing environment 100 (e.g., the state manager 102, the service manager 108, the input device 104, the first computing node 106a, and the second computing node 106b) may be communicatively coupled via a network 107, such as a local area network (LAN), wide area network (WAN), the Internet, or any suitable network.

The state manager 102 may be a server-based software service that may, among performing other operations, orchestrate multi-node operations (e.g., software service interactions). Additionally, the service manager 108 may be a multi-node service controller designed to manage services across multiple nodes in a multi-node computing environment. An example of the service manager is Eclipse BlueChi™. The state manager 102 can communicate with the service manager 108 to orchestrate multi-node operations.

Additionally, the multi-node computing environment 100 may be an edge computing system and the computing nodes 106a-b may be edge nodes. Thus, the computing nodes 106a-b may have limited computing resources (e.g., RAM, storage, processing power, etc.). Examples of edge computing systems include autonomous vehicles, medical device monitoring systems, security systems, traffic management systems, smart home devices, etc. Examples of edge nodes in an edge computing system include sensors, actuators, thermometers, controllers, scanners, medical devices, scientific instruments, routers, network access devices, desktop computers, laptop computers, servers, mobile phones, tablets, and the like.

In some examples, upon a startup of the edge computing system, the state manager 102 may access a first state 128a of the first computing node 106a and a second state 128b of the second computing node 106b of the edge computing system. A state of a computing node may include an operational status of the computing node (e.g., offline, online, booting), software service states of software services executing on the computing node (e.g., information indicative which software services are enabled on the computing node), resource metrics of the computing node (e.g., CPU load, memory usage, or disk space), a network status of the computing node (e.g., connected, disconnected, bandwidth, etc.) power condition (e.g., battery level or whether the computing node is plugged into an energy source), or the like.

In addition to accessing the first state 128a of the first computing node 106a and the second state 128b of the second computing node 106b, the state manager 102 can initiate a synchronization mechanism 118. As a result, the synchronization mechanism 118 can provide notifications to the state manager 102 in response to changes in the first state 128a of the first computing node 106a or the second state 128b of the second computing node 106b. For example, the synchronization mechanism 118 may provide a notification to the state manager 102 if the first state 128a of the first computing node 106a changes from online to offline. In another example, the synchronization mechanism 118 may provide a notification to the state manager 102 when a software service on one of the computing nodes 106a-b is activated and may provide another notification when the software service is deactivated.

Thus, the state manager 102 can monitor and obtain information related to states of the computing nodes 106a-b, including software service states 116 of software services 134a-b that may executing on the computing nodes. The state manager 102 may further access the configuration data 110 related to the computing nodes 106a-b, software services 134a-b, or a combination thereof. The configuration data may include configuration files or other types of configuration data which may be in YAML format or a custom domain specific language. The configuration data may include information about events, workflows, and operations.

An event name in the configuration may define an event. The event name can further imply an objective of the event with respect to the multi-node computing environment 100. For example, event names of events associated with a vehicle may be “unlock-doors” or “activate-collision-sensor”. There may be two kinds of events associated with a multi-node computing system: external events and internal events. Internal events may describe a state change within a system. For example, activation of the collision sensor event may be an internal event that occurs automatically during operation of the vehicle. In contrast, an external event may be triggered when a user interacts with the multi-node computing environment 100 (e.g., via the input device 104). For example, the “unlock-doors” event may be triggered when a user hits an unlock button on a key fob.

Additionally, an operation may be an executable step that the state manager 102 can trigger. Examples of operations include starting a software service, checking a status of a software service, or transmitting a command to a computing node. Conversely, a workflow may be a series of interdependent operations that the state manager 102 may trigger. A workflow may therefore include two or more operations which may be carried out using one or more computing nodes of the multi-node computing environment 100 to achieve a desired outcome. The two or more operations may be interdependent in that execution of an operation may depend on a successful completion of or a status of another operation. The configuration data 110 may associate one or more workflows or operations with the events. As such, the configuration data 110 can indicate executable steps to be triggered by the state manager 102 in response to an external or internal event.

In some examples, the state manager 102 may receive a request 138 to execute an external event 112 from an input device 104. The request 138 may include an indication of the external event 112 and a communication protocol used to initiate the request (e.g., CAN, MQTT, or REST). In a particular example, if the multi-node computing environment 100 is a medical device monitoring system, the state manager 102 may receive the request 138 as a result of a user selecting a button on a user interface of an input device (e.g., input device 104). Alternatively, the state manager 102 may receive the request 138 as a result of a computing node detecting an unintended user interaction. For example, the medical device monitoring system may include a heart rate monitor and the request 138 may be transmitted in response to the heart rate monitor detecting an increase in a heart rate of the user.

In either case, in response to receiving the request 138 to execute the external event 112, the state manager 102 may identify an operation or workflow (e.g., a series of operations) involved in execution of the external event 112. The state manager 102 may use the configuration data 110 to identify the operations or workflows associated with the external event 112. For example, the configuration data 110 may associate the external event 112 with a workflow 120 that involves operations 122, 124, 126. The configuration data 110 may define the operations 122, 124, 126, an order in which the operations 122, 124, 126 are to be performed, any dependence among the operations 122, 124, 126. For example, the external event 112 may be “measure-temperature-bloodpressure.” Thus, a first operation 122 may involve activating the first computing node (e.g., a blood pressure cuff), a second operation 124 may involve activating a first software service 134a executing on the blood pressure cuff for recording a blood pressure measurement, and a third operation 126 may involve activating a second software service 134b executing on a second computing node (e.g., a smart thermometer) for recording a body temperature.

After identifying the operation or workflow to involved in execution of the external event 112, the state manager 102 may control the computing nodes 106a-b associated with the operation or workflow. In particular, the state manager 102 may control the computing nodes 106a-b to execute the external event 112 by causing the computing nodes 106a-b to perform the operation or workflow. In some examples, the state manager 102 may control the computing nodes 106a-b by transmitting commands to the computing nodes 106a-b to cause the computing nodes to perform the operations 122, 124, 126. In the particular example, the state manager 102 may transmit a first command to cause the first computing node 106a to activate. Then, the state manager 102 may receive a notification indicating that the first computing node 106a is active, and, as a result, transmit another command to activate the first software service 134a on the first computing node 106a. Moreover, the state manager 102 may transmit a third command to the second computing node 106b to activate the second software service 134b.

Alternatively, in some examples, the state manager 102 may control the computing nodes 106a-b by transmitting a request 136 to execute the external event 112 to the service manager 108. The service manager may deploy software agents 114a-b on each of the computing nodes 106a-b. The software agents 114a-b may each interact with the software services 134a-b executing on the computing nodes 106a-b. For example, the software agents 114a-b may interact with the software services by checking states of the software services 134a-b, starting or stopping the software services 134a-b, enabling or disabling the software services 134a-b, or monitoring lifecycle events of the software services 134a-b (e.g., starting, running, or failure of the software service).

Thus, by transmitting the request 136 to execute the external event 112 to the service manager 108, the state manager 102 can cause the service manager 108 to transmit commands to the computing nodes 106a-b to cause the computing nodes 106a-b to perform one or more of the operations 122, 124, 126. For example, in response to receiving the request 136, the service manager 108 may carry out the first operation (e.g., transmit a first command to cause the first computing node 106a to activate).

Then, the state manager 102 may receive a notification indicating that the first computing node 106a is active, and, as a result, transmit another request to the service manager 108 to cause the service manager 108 to transmit a command to activate the first software service 134a on the first computing node 106a. The service manager 108 may more specifically transmit a command to the first software agent 114a to cause the first software agent 114a to perform the second operation 124 (e.g., to activate the first software service 134a). Moreover, as a result of the request 136, the service manager 108 may transmit a command to the second software agent 114b to cause the second software agent 114b to perform the third operation 126 (e.g., to activate the second software service 134b).

As mentioned above, the configuration data 110 may indicate that some operations depend on another operation. For example, the second operation 124 may be dependent on successful completion of the first operation 122 (e.g., activation of the first computing node 106a). Thus, after controlling the first computing node 106a to cause the at first computing node 106a to perform the first operation (e.g., to activate), the state manager 102 may receive a status of the first computing node 106a. As also mentioned above, in one example the state manager 102 may receive a notification (e.g., including a status of the first computing node) indicating that the first computing node 106a is active. The state manager 102 may receive the notification from the synchronization mechanism 118 or the service manager 108. In response to the status of the first computing node indicating that the first operation was performed successfully, the state manager 102 may control the first computing node 106a to cause the first computing node 106a to perform the second operation 124 and/or control the second computing node 106b to cause the second computing node 106b to perform the third operation 126. In contrast, in response to the status of the first computing node 106a indicating that the first operation 122 was not performed successfully, the state manager 102 may prevent performance of the second and/or third operations 124, 126.

While FIG. 1 depicts a specific arrangement of components, other examples can include more components, fewer components, different components, or a different arrangement of the components shown in FIG. 1. For instance, in other examples, the multi-node computing environment 100 can include a different number of computing nodes. Additionally, any component or combination of components depicted in FIG. 1 can be used to implement the process(es) described herein.

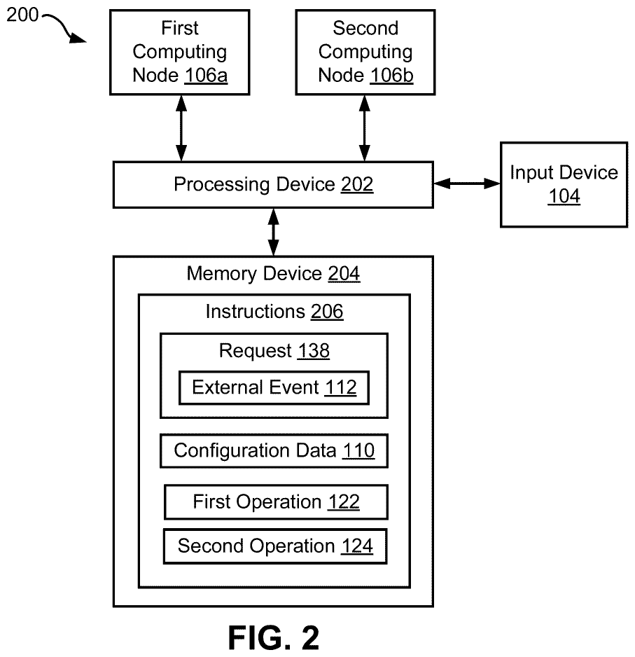

FIG. 2 is a block diagram of a computing environment 200 for managing software service operations in multi-node environments (e.g., the multi-node computing environment 100 of FIG. 1) according to some aspects of the present disclosure. The computing environment 200 can include a processing device 202 communicatively coupled to a memory device 204.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C #, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code. Non-limiting examples of a computer-readable medium include magnetic disk(s), memory chip(s), ROM, random-access memory (RAM), an ASIC, a configured processor, and optical storage.

In some examples, the processing device 202 can receive a request 138 to execute an external event 112 from an input device 104 of an edge computing system (e.g., the multi-node computing environment 100 of FIG. 1). In response to receiving the request to execute the external event 112, the processing device 202 can identify one or more operations (e.g., first operation 122 and second operation 124) involved in execution of the external event 112 based on configuration data 110 associated with the edge computing system. The processing device 202 may then control at least one computing node (e.g., first computing node 106a and second computing node 106b) of the edge computing system to cause the at least one computing node to execute the external event 112 by performing the first operation 122 and the second operation 124.

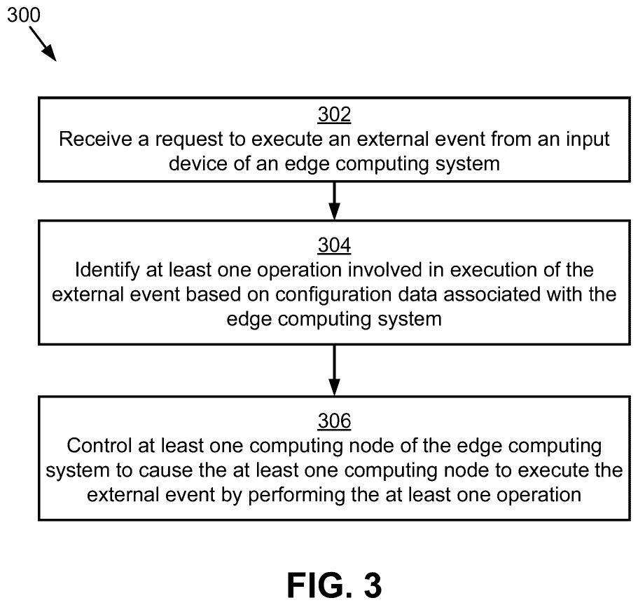

FIG. 3 is a flow chart of an example of a process for managing software service operations in multi-node environments (e.g., the multi-node computing environment 100 or the computing environment 200), according to some aspects of the present disclosure. In some examples, the processing device 202 can perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

At block 302, the processing device 202 can receive a request 138 to execute an external event 112 from an input device 104 of an edge computing system. In an example, a distributed edge computing system may include a self-service kiosk. A user may use the self-service kiosk to check in for a flight. Thus, the processing device 202 may receive the request 138 in response to the user selecting a check in option on a user interface of the self-service kiosk. The external event 112 may, in the example, be a user authentication and check in process.

At block 304, the processing device 202 can identify at least one operation involved in execution of the external event based on configuration data associated with the edge computing system. In the example, the configuration data can indicate that the external event involves a first operation 122 in which a passenger validation service of the first computing node (e.g., an airport regional node) may confirm that there is a flight reservation associated with the user. Additionally, in the example, the configuration data can indicate that the external event involves a second operation 124 in which a reservation update service of the second computing node (e.g., an airline data center) may mark a passenger as checked-in.

At block 306, the processing device 202 can control at least one computing node of the edge computing system to execute the external event by performing the at least one operation. In the example, to control the computing nodes 106a-b, the processing device 202 may transmit a request for the computing nodes 106a-b to execute the external event to a service manager 108. The service manager may be a multi-node service controller designed to manage services across multiple nodes. An example of the service manager is Eclipse BlueChi™.

The service manager may deploy a software agent on each of the computing nodes 106a-b. The software agents may each interact with software services executing on the computing nodes 106a-b. For example, the software agents may interact with one or more of the software services by checking a state of a software services, starting or stopping a software service, enabling or disabling a software service, or monitor lifecycle events of a software service (e.g., starting, running, or failure of the software service).

Thus, by transmitting the request to execute the external event to the service manager 108, the processing device 202 can cause the service manager 108 to transmit a first command to a first software agent executing on the first computing node 106a. In response to receiving the first command, the first software agent can activate the passenger validation service to confirm that there is a flight reservation associated with the user. Additionally, by transmitting the request to execute the external event to the service manager 108, the processing device 202 can cause the service manager 108 to transmit a second command to a second software agent executing on the second computing node 106b. In response to receiving the second command, the second software agent can activate the reservation update service to mark the user as checked in.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any example(s) described herein can be combined with any other example(s) to yield further examples.

1. A system comprising:
a processing device; and
a memory comprising instructions that are executable by the processing device for causing the processing device to:
receive a request to execute an external event from an input device of an edge computing system that includes the input device and a plurality of edge nodes that are configured to store or process data obtained via the edge computing system;
in response to receiving the request to execute the external event, identify at least one operation for being performed by at least one of the plurality of edge nodes and involved in execution of the external event based on configuration data associated with the edge computing system; and
control the at least one of the plurality of edge nodes to execute the external event by causing the at least one of the plurality of edge nodes to perform the at least one operation.

2. The system of claim 1, wherein the at least one operation comprises executing at least one software service on the at least one of the plurality of edge nodes or identifying a state of the at least one software service.

3. The system of claim 1, wherein the at least one operation comprises a first operation and a second operation, wherein the at least one of the plurality of edge nodes comprises a first edge node and a second edge node, and wherein the controlling the at least one of the plurality of edge nodes comprises:
controlling the first edge node to cause the first edge node to perform the first operation; and
receiving a status of the first edge node that indicates whether the first operation was performed successfully.

4. The system of claim 3, wherein the controlling the at least one of the plurality of edge nodes comprises:
in response to the status of the first edge node indicating that the first operation was performed successfully, controlling the second edge node to cause the second edge node to perform the second operation.

5. The system of claim 3, wherein the controlling the at least one of the plurality of edge nodes comprises:
in response to the status of the first edge node indicating that the first operation was not performed successfully, preventing the second edge node from performing the second operation.

6. The system of claim 1, wherein the memory further comprises instructions that are executable by the processing device for causing the processing device to:
upon a startup of the edge computing system:
access a state of each of the plurality of edge nodes; and
initiate a synchronization mechanism that provides a notification in response to a change in the state of any of the plurality of edge nodes.

7. The system of claim 1, wherein the controlling the at least one of the plurality of edge nodes to execute the external event comprises transmitting a request for the at least one of the plurality of edge nodes to execute the external event to a service manager.

8. A computer-implemented method comprising:
receiving a request to execute an external event from an input device of an edge computing system that includes the input device and a plurality of edge nodes that are configured to store or process data obtained via the edge computing system;
in response to receiving the request to execute the external event, identifying at least one operation for being performed by at least one of the plurality of edge nodes and involved in execution of the external event based on configuration data associated with the edge computing system; and
controlling the at least one of the plurality of edge nodes to execute the external event by causing the at least one of the plurality of edge nodes to perform the at least one operation.

9. The computer-implemented method of claim 8, wherein the at least one operation comprises executing at least one software service on the at least one of the plurality of edge nodes or identifying a state of the at least one software service.

10. The computer-implemented method of claim 8, wherein the at least one operation comprises a first operation and a second operation, wherein the at least one of the plurality of edge nodes comprises a first edge node and a second edge node, and wherein the controlling the at least one computing node of the edge computing system comprises:
controlling the first edge node to cause the first edge node to perform the first operation; and
receiving a status of the first edge node that indicates whether the first operation was performed successfully.

11. The computer-implemented method of claim 10, wherein the controlling the at least one of the plurality of edge nodes comprises:
in response to the status of the first edge node indicating that the first operation was performed successfully, controlling the second edge node to cause the second edge node to perform the second operation.

12. The computer-implemented method of claim 10, wherein the controlling the at least one of the plurality of edge nodes comprises:
in response to the status of the first edge node indicating that the first operation was not performed successfully, preventing the second edge node from performing the second operation.

13. The computer-implemented method of claim 8, further comprising, upon a startup of the edge computing system:
accessing a state of each of the plurality of edge nodes; and
initiating a synchronization mechanism that provides a notification in response to a change in the state of any of the plurality of edge nodes.

14. The computer-implemented method of claim 8, wherein the controlling the at least one of the plurality of edge nodes to execute the external event comprises transmitting a request for the at least one of the plurality of edge nodes to execute the external event to a service manager.

15. A non-transitory computer-readable medium comprising program code that is executable by a processing device for causing the processing device to:
receive a request to execute an external event from an input device of an edge computing system that includes the input device and a plurality of edge nodes that are configured to store or process data obtained via the edge computing system;
in response to receiving the request to execute the external event, identify at least one operation for being performed by at least one of the plurality of edge nodes and involved in execution of the external event based on configuration data associated with the edge computing system; and
control the at least one of the plurality of edge nodes to execute the external event by causing the at least one of the plurality of edge nodes to perform the at least one operation.

16. The non-transitory computer-readable medium of claim 15, wherein the at least one operation comprises executing at least one software service on the at least one of the plurality of edge nodes or identifying a state of the at least one software service.

17. The non-transitory computer-readable medium of claim 15, wherein the at least one operation comprises a first operation and a second operation, wherein the at least one of the plurality of edge nodes comprises a first edge node and a second edge node, and wherein the controlling the at least one computing node of the edge computing system comprises:
controlling the first edge node to cause the first edge node to perform the first operation; and
receiving a status of the first edge node that indicates whether the first operation was performed successfully.

18. The non-transitory computer-readable medium of claim 17, wherein the controlling the at least one of the plurality of edge nodes comprises:
in response to the status of the first edge node indicating that the first operation was performed successfully, controlling the second edge node to cause the second edge node to perform the second operation.

19. The non-transitory computer-readable medium of claim 17, wherein the controlling the at least one of the plurality of edge nodes comprises:
in response to the status of the first edge node indicating that the first operation was not performed successfully, preventing the second edge node from performing the second operation.

20. The non-transitory computer-readable medium of claim 15, wherein the program code executable by the processing device further causes the processing device to:
upon a startup of the edge computing system:
access a state of each of the plurality of edge nodes; and
initiate a synchronization mechanism that provides a notification in response to a change in the state of any of the plurality of edge nodes.
